(19) United States
(12) Patent Application Publication
(10) Pub. No.: US 2004/0079504 A1
(43) Pub. Date: Apr. 29, 2004

(54) Doped precipitate silica suspensions with low-particle-size distribution and their use a paper filler

(76) Inventors: Marie-Odile Lafon, Paris (FR); Christophe Eychenne-Baron, Paris (FR); Jean-Noel Jas, Princeton, NJ (US)

Correspondence Address: BURNS DOANE SWECKER & MATHIS L L P, POST OFFICE BOX 1404, ALEXANDRIA, VA, 22313-1404, US

(21) Appl. No.: 10/451,879

(22) PCT Filed: Dec. 24, 2001
(86) PCT No.: PCT/FR01/04193

(30) Foreign Application Priority Data
Dec. 27, 2000 (FR) 00/17119

(51) Int. Cl. C01B 33/12; D21H 17/69

(52) U.S. Cl. 162/181.6; 423/335

(57) ABSTRACT

The invention concerns a precipitate silica suspension, said silica containing, bound to its surface at least a metal element at least divalent. The invention is characterised in that the silica particles have a median diameter in volume less than 2 μm. The invention further concerns the use of said suspension as paper filler and more particularly for enhancing printing properties.

The present invention mainly relates to a precipitated silica suspension with a low particle size and is also targeted at the application of this suspension as paper filler in particular for the purpose of improving the printing quality thereof.

It is known that some silicas can be advantageously used in the manufacture of paper, either as bulk filler for ordinary paper of newsprint type or as coating filler for special paper demanding a higher surface quality, such as, for example, paper for color inkjet printers.

Incorporated in the body of the paper, the silicas can make it possible to significantly improve one or more of the following properties: opacity, whiteness, density, porosity, mechanical properties and the like.

Some types of paper, referred to as special paper, have in addition to exhibit a very high surface quality. This is the case, for example, with paper for color inkjet printers, which is required to make possible high-definition color reproduction. This surface condition can then be obtained by coating the paper sheets with silica-based coating baths.

It is known that the improvements in the properties, either bulk or surface properties, thus sought for the paper are related to the physical characteristics of structure and of morphology of the silicas used. These characteristics are in particular the specific surface, the pore size and volume, and the size of the aggregates and agglomerates, which therefore have to be suitably adjusted according to the intended result.

Recently, it has been shown that some of the properties sought for bulk fillers or coating fillers for paper depend not only on the structural characteristics of the silicas used but also on their surface chemistry. In particular, it has been found that the control of this surface chemistry makes it possible to advantageously influence properties such as the chemical retention and the adsorption capacity. The chemical retention quantifies the ability of the silica to be retained by adsorption on the cellulose fibers of the paper. It is defined as the ratio of the amount of silica actually adsorbed on the cellulose fibers to the total amount of silica used during the bulk incorporation.

Thus, in patent EP 493 263, it is disclosed that precipitated silicas, modified so as to exhibit a surface chemistry such that their number of cationic sites, expressed as micromole/m² of silica, is greater than 0.05 and comprising at least one at least divalent metal element chemically bonded to their surface, such as alkaline earth metals, titanium, zirconium and aluminum, allow satisfaction to be achieved in terms of chemical retention.

These silicas are generally obtained by treatment of a suspension of precipitated silica, obtained by a conventional synthetic process, with an organic or inorganic salt of the metal element under consideration. On conclusion of this treatment, the entire surface of the silica grains is chemically modified using the metal element. In the specific case where treatment of the silica is carried out using alumina, there is no alumina outside the grains, that is to say apart from the surface of the silica.

This doped silica is isolated, dried and generally granulated. This silica powder is provided with a particle size of 3 μm for application as bulk filler for improving the retention of paper.

For its part, the present invention relates more particularly to the improvement in the printing quality with regard to paper. Unexpectedly, it has thus been demonstrated that it is possible to improve the printing qualities of paper by virtue of the presence in the latter of doped silica particles with a significantly smaller particle size in comparison with conventional silica particles.

Consequently, a first aspect of the invention relates to a suspension of doped precipitated silica with a low particle size.

In a second aspect, the present invention is targeted at the application of this suspension as bulk filler in paper and in particular for improving the printing qualities of the latter.

A first subject matter of the present invention is therefore a suspension of precipitated silica, to the surface of which is chemically bonded at least one at least divalent metal element, characterized in that the silica particles have a median diameter by volume of less than 2 μm.

Unexpectedly, the inventors have thus demonstrated that it is possible to achieve bulk fillers made of silica with a low particle size formulated in the form of a suspension and that this type of suspension, mixed with cellulose fibers, results in a paper which is advantageous in terms of printing and of retention. Contrary to all expectations, the small size of the doped silica particles does not prove to be harmful in terms of retention.

As emerges from the examples presented hereinbelow, paper sheets comprising a silica in accordance with the present invention display a better retention with respect to the ink in comparison with sheets incorporating a silica having a median diameter by volume of greater than 2 μm.

Furthermore, unexpectedly, this better retention is not reflected by a greater absorption of the inks. The printing quality is unaffected.

According to a preferred alternative form of the invention, the silica particles have a median diameter by volume of less than 1 μm and in particular of less than 0.8 μm.

The median diameter (d50) by volume is determined by laser diffraction according to the standard NF X11′-666.

The amount of the at least divalent metal element bonded to the surface of the silica can vary within wide limits. Preferably, this metal element is present at the surface of the silica in a proportion of 0.01 to 30% by weight, more preferably in a proportion of 0.5 and 15% by weight and in particular of between 3 and 10% by weight, depending on the specific surface of the silica.

The percentages are expressed as weight of the metal under consideration, for example aluminum, with respect to the weight of silica.

Mention may more particularly be made, by way of representation of the metal elements which can be bonded to the surface of the silica, of alkaline earth metals, such as, for example, calcium, magnesium, zinc, strontium and barium; titanium; zirconium; and aluminum. According to a preferred embodiment of the invention, the metal element is aluminum.

The claimed silica suspension preferably exhibits a silica content varying from 4 to 50% by weight, preferably of between 5 and 30% by weight and more preferably of between 8 and 20% by weight.

As regards more particularly the silica, it exhibits (in the dry state) a BET specific surface of between 50 and 700 m²/g, preferably between 50 and 250 m²/g, in particular between 100 and 200 m²/g.

The BET specific surface is determined according to the Brunauer-Emmet-Teller method described in The Journal of the American Chemical Society, Vol. 60, page 309, February 1938, and corresponding to the standard NFT 45007 (November 1987).

As regards the preparation of the claimed silica suspensions, it involves carrying out the doping of a precipitated silica.

The surface treatment of the silica using an at least divalent metal element can be carried out according to one of the processes disclosed in patents EP 493 263, EP 762 992 or EP 762 993, the teaching of which is entirely included here by way of reference.

Generally, first of all a silicate is reacted with an acidifying agent, whereby, by precipitation, a precipitated silica suspension is obtained.

The choice of the acidifying agent and of the silicate is made in a way well-known per se.

Use is generally made, as acidifying agent, of a strong inorganic acid, such as sulfuric acid, nitric acid or hydrochloric acid, or of an organic acid, such as acetic acid, formic acid or carbonic acid.

Furthermore, use may be made, as silicate, of any common form of silicate, such as metasilicates, disilicates and advantageously a silicate of an alkali metal, in particular sodium or potassium silicate. The silicate is generally used in the form of an aqueous solution which can exhibit a concentration of silicate, expressed as SiO₂, of between 40 and 330 g/l, for example between 60 and 300 g/l, in particular between 60 and 250 g/l.

Use is preferably made, as acidifying agent, of sulfuric acid and, as silicate, of sodium silicate.

The surface treatment is generally carried out on the precipitated silica suspension obtained at the end of precipitation and before filtration and/or after disintegration of the filtration cake obtained after filtration, according to one of the protocols described in the abovementioned patents.

Generally, the metal elements are employed in the form of one of their organic or inorganic salts.

Mention may in particular be made, as organic salts, of salts of carboxylic or polycarboxylic acids, such as, for example, acetic, citric, tartaric or oxalic acid.

Mention may in particular be made, as inorganic salts, of halides and oxyhalides, such as, for example, chlorides and oxychlorides; nitrates; phosphates; or sulfates and oxysulfates.

In practice, the metal salts are introduced into the silica suspension in the form of solutions, generally aqueous solutions; these salts could also, of course, be introduced in the solid form, their dissolution then occurring after being brought into contact with the silica dispersion. Preferably, the solutions of metal salts are introduced gradually into the suspensions of silicas, in one or several stages.

On conclusion of the surface treatment and before drying, a silica suspension is obtained. Generally, the median diameter by volume of the silica particles in suspension is greater than 1 μm. It is therefore appropriate to adjust it to a value in accordance with the invention. This adjustment can be carried out using ultrasound.

It is also possible to envisage preparing a silica suspension in accordance with the invention by suspending a powder formed from precipitated silica doped at the surface by at least one at least divalent metal element as defined above and with particles having a median diameter by volume of greater than 1 μm. The size of the particles in suspension is then adjusted to a value in accordance with the invention, that is to say less than 2 μm.

A second aspect of the invention relates to the use as paper filler of a suspension of precipitated silica, to the surface of which is chemically bonded at least one at least divalent metal element, the silica particles of which have a median diameter by volume of less than 2 μm and preferably of less than 1 μm.

A third subject matter of the invention is a process for improving the printing qualities of paper, characterized in that it employs, as paper filler, a suspension of precipitated silica, to the surface of which is chemically bonded at least one metal element which is at least divalent, the particles of which have a median diameter by volume of less than 2 μm and preferably of less than 1 μm.

Advantageously, the silica suspension used is a silica suspension as defined above.

Generally, the silica suspension is used in a proportion of 1 to 50% by weight and preferably between 5 and 50% by weight, expressed as dry weight of silica, with respect to the weight of cellulose fibers constituting the paper.

The examples which appear hereinbelow are presented by way of illustration and without limitation of the subject matter of the present invention.

Equipment and Method

Characterization

Measurement of the Decree of Retention

A paper sheet recovered on a device for preparing handsheets is dried in a stove for at least 12 hours at 80° C. It is weighed and the weight P1 is obtained.

It is subsequently calcined at 450° C. in an oven for 2 hours. At the outlet of the oven, it is cooled in a desiccator and then weighed when cold. The weight P2 is obtained.

The ratio P2/P1 gives the percentage of fillers present in the sheet. The ratio of this percentage to the initial percentage introduced during the manufacture of the suspension gives the degree of retention of the fillers.

Description of the Test for Evaluating the Quality of the Printed Ink

Paper sheets are printed without any surface treatment. Ink-jet printing is carried out using an Epson Stylus Photo EX printer. The quality of the ink is assessed according to 3 criteria:

the color density, evaluated using an X-Rite 404 densitometer.

the curvature of the points of ink, observed with an optical microscope. This measurement is only of a quantitative nature.

the homogeneity of the printing, which is carried out by visual evaluation on a printing model.

For each comparison, a set of specific paper is produced and printed. From one set to another, the optical density values can vary significantly for the same silica because of significant differences with regard to the pulp or even with regard to the printing. Consequently, comparisons are only possible within the same set of copies cut from one sheet.

Principle of the Particle Size Measurement

The median diameter (d50) by volume is determined by laser diffraction according to the standard NF X11-666, using a Coulter LS 230® laser particle sizer.

Operating Conditions

Procedure for Producing a Paper Sheet

The pulp chosen is a mixture of 80% short fibers and 20% long fibers with a Shopper-Riegler refining of 30°.

The silica is added in a proportion of 16.7% or 9.1% by weight with respect to the weight of fibers. The pH is retained at its original value, which is generally approximately 4.

The suspension of cellulose and of fillers is diluted to 0.5% by addition of water.

A paper sheet is subsequently manufactured by using the “device for preparing handsheets” by Ernst Haage. The amount of suspension introduced into the device is adjusted in order to obtain a grammage of 80 g/m².

### EXAMPLE 1

Process for Producing Aluminum-Doped Silica Suspensions

Precipitation of the Silica:

9.8 liters of water and 0.211 liter of aqueous sodium silicate, exhibiting an SiO₂/Na₂O ratio by weight of 3.45 and a density at 20° C. of 1.223, are introduced into a 30-liter reactor.

The mixture is then brought to 85° C. while keeping it stirred. 0.209 liter of dilute sulfuric acid, with a density at 20° C. of 1.050, is then added thereto until a pH value (measured at the temperature of the reaction medium) of 7.5 is obtained in the reaction medium.

3.7 liters of aqueous sodium silicate of the type described above and 4.7 liters of sulfuric acid, also of the type described above, are then jointly introduced into the reaction medium, this simultaneous introduction of acid and silicate being carried out such that the pH of the reaction medium, during the period of introduction, is always equal to 8.2. After introducing all the silicate, the introduction of the dilute acid is continued until a pH of 4 is obtained.

A reaction slurry is obtained, which slurry is filtered and washed by means of a vacuum filter. The silica cake thus obtained exhibits a solids content of 15.2%.

Doping with Aluminum:

850 g by mass of dry silica of the cake synthesized above and 0.5 liter of water are introduced into a 30-liter reactor. The mixture is brought to 60° C. with stirring; 2108 grams of 260 g/l aluminum sulfate are then added thereto. The pH is 2.8 at the end of the addition. The pH is subsequently adjusted to 6 by addition of 5N sodium hydroxide solution, followed by a stage of maturing for 30 minutes at this pH. The pH is brought to 4 by addition of sulfuric acid (80 g/l), followed by a second stage of maturing for 10 minutes at this pH.

A reaction slurry is obtained, which slurry is filtered and washed by means of a vacuum filter and dried by atomization. The silica obtained exhibits a solids content of 95%.

Preparation of the Doped Silica Suspensions:

The silica obtained in the preceding stage is dispersed in water in order to obtain a solids content of 6%.

A first part of the suspension is kept back and the corresponding silica is employed as control in example 2. It exhibits a d50 by volume of 7 μm.

The second part of the suspension is, for its part, subjected to treatment with ultrasound for 3 minutes 30 using a Vibracell Bioblock (300 W)® ultrasound generator equipped with a probe with a diameter of 19 mm with a tip, in order to obtain a d50 by volume of 0.5 μm. The suspension obtained is an aluminum-doped silica suspension exhibiting a d50 by volume of 0.5 μm.

### EXAMPLE 2

Use of the Silica Suspensions of Example 1 as Paper Filler

Two silica suspensions obtained in example 1, the specific characters of the silicas of which are presented in table 1, are incorporated in paper pulps prepared according to the protocol described in the EQUIPMENT AND METHOD part.

TABLE 1

| | | d50 by volume of the |
|---|---|---|
| | % Al (by weight) | particles (μm) |
| Silica A | 5 | 7 |
| Silica B | 5 | 0.5 |

The results obtained for retention with these two silicas are presented in table 2:

TABLE 2

| | Test | Initial amount | Level of filler | Degree of |
|---|---|---|---|---|
| | No. | introduced (%) | in the sheet | retention |
| Silica A | 1 | 16.7 | 7 | 42 |
| Silica B | 2 | 16.7 | 12.5 | 75 |
| Silica B | 3 | 9.1 | 7 | 77 |

A better retention is observed with a silica suspension in accordance with the invention.

Furthermore, contrary to all expectations, this improvement in terms of retention is not harmful in terms of absorption of ink by the paper.

Thus, as illustrated in table 3 hereinbelow, optical density measurements carried out on paper sheets comprising the same amount of silica, either in accordance with the invention (test 1) or control (test 3), prove to be comparable.

Advantageously, a greater absorption of ink is not observed with a silica in accordance with the invention.

TABLE 3

| | Optical | Optical density | Optical density | Optical |
|---|---|---|---|---|
| | density red | yellow | black | density blue |
| Silica A, | 1.11 | 0.95 | 1.5 | 1.21 |
| test 1 | | | | |
| Silica B, | 1.03 | 0.99 | 1.46 | 1.15 |
| test 3 | | | | |

1. A suspension of precipitated silica, to the surface of which is chemically bonded at least one at least divalent metal element, characterized in that the particles of said silica have a median diameter by volume of less than 2 μm.

2. The suspension as claimed in claim 1, characterized in that the silica particles have a median diameter by volume of less than 1 μm and in particular of less than 0.8 μm.

3. The suspension as claimed in either of the preceding claims, characterized in that the metal element is present at the surface of the silica in a proportion of 0.01 to 30% by weight and more preferably in a proportion of 0.5 and 15% by weight.

4. The suspension as claimed in one of the preceding claims, characterized in that the metal element bonded to the surface of the silica is aluminum.

5. The suspension as claimed in one of the preceding claims, characterized in that it has a silica content varying from 4 to 50% by weight and preferably of between 5 and 30% by weight.

6. The suspension as claimed in one of the preceding claims, characterized in that said silica exhibits a BET specific surface of between 50 and 700 m²/g, preferably between 50 and 250 m²/g.

7. Use as paper filler of a suspension of precipitated silica, to the surface of which is chemically bonded at least one at least divalent metal element, said silica having a median diameter by volume of particles of less than 2 μm.

8. The use as claimed in claim 7, characterized in that the suspension is as defined in one of claims 2 to 6.

9. The use as claimed in claim 7 or 8, characterized in that the silica suspension is used in the proportion of 1 to 50% by weight and preferably between 5 and 50% by weight, expressed as dry weight of silica, with respect to the weight of cellulose fibers constituting the paper.

10. A process for improving the printing qualities of paper, characterized in that it employs, as paper filler, a suspension of precipitated silica, to the surface of which is chemically bonded at least one at least divalent metal element, the silica particles of which have a median diameter by volume of less than 2 μm.

11. The process as claimed in claim 10, characterized in that the said suspension is as defined in one of claims 2 to 6.

12. The process as claimed in claim 10 or 11, characterized in that the silica suspension is used in a proportion of 1 to 50% by weight and preferably between 5 and 50% by weight, expressed as dry weight of silica, with respect to the weight of cellulose fibers constituting the paper.
